(19) United States
(12) Patent Application Publication
(10) Pub. No.: US 2025/0285789 A1
(43) Pub. Date: Sep. 11, 2025

(54) Ce-CONTAINING NEODYMIUM-IRON-BORON MAGNET AND PREPARATION METHOD AND APPLICATION THEREOF

(71) Applicant: BEIJING ZHONG KE SAN HUAN HI-TECH CO., LTD., Beijing (CN)

(72) Inventors: Yunqiao WANG, Beijing (CN); Fengqiao LIU, Beijing (CN); Wei ZHU, Beijing (CN); Bin FANG, Beijing (CN); Fei DU, Beijing (CN); E NIU, Beijing (CN)

(21) Appl. No.: 19/017,144

(22) Filed: Jan. 10, 2025

(30) Foreign Application Priority Data
Mar. 8, 2024 (CN) 202410269454.2

(51) Int. Cl. H01F 1/057

(52) U.S. Cl. CPC H01F 1/0576

(57) ABSTRACT

A Ce-containing NdFeB magnet includes thin-shell grains, reverse-shell grains, and thick-shell grains. The reverse-shell grain has a higher HRE content in the core than in the shell. Both the thick-shell grain and the thin-shell grain have a higher HRE content in the shell than in the core. The thickness of the shell of the thin-shell grains is less than 2 μm. In the surface region of the Ce-containing NdFeB magnet, the number of thin-shell grains is N₁, and the total number of grains in the Ce-containing neodymium-iron-boron magnet is N. In the near-surface region of the Ce-containing neodymium-iron-boron magnet, the number of reverse-shell grains is N₂, the number of thick-shell grains is N₃, and the total number of grains in the Ce-containing neodymium-iron-boron magnet is N′. N₁/N is greater than 70%, and (N₂+N₃)/N′ is less than 5%.

### CROSS-REFERENCE TO RELATED APPLICATION

This application claims priority to Chinese Application No. 202410269454.2, filed on Mar. 8, 2024, the entire content of which is incorporated herein by reference.

### TECHNICAL FIELD

The present disclosure relates to the field of rare earth permanent magnets, specifically to Ce-containing neodymium iron boron (NdFeB) magnets, their preparation methods, and applications.

### BACKGROUND

NdFeB rare earth permanent magnet materials represent the strongest magnetic materials discovered to date, and they have found widespread applications in an increasing number of fields due to their excellent magnetic properties, including medical magnetic resonance imaging (MRI), computer hard disk drives, audio mobile phones, wind power generation, and aerospace. With the rising demand for low-carbon and energy-saving solutions, the application of NdFeB rare earth permanent magnet materials in automobile motors and energy-efficient appliances is becoming more prevalent.

In recent years, the price of PrNd rare earth, a primary raw material, has experienced significant fluctuations, leading to increased market sensitivity to raw material price changes. As a rare earth element, the natural abundance of cerium (Ce) is considerably higher than that of neodymium (Nd), with the price of Ce being approximately one-tenth that of Nd. The use of Ce as a substitute for PrNd in the production of Ce-containing magnets can reduce raw material costs. As the application range of Ce-containing magnets expands, there is a growing demand for these magnets to exhibit high coercivity and good temperature stability.

To enhance the coercivity of Ce-containing magnets, a grain boundary diffusion method can be employed. One approach involves conducting grain boundary diffusion near the melting point of ReFe₂ to mitigate the effects of relative diffusion at the ReFe₂ grain boundaries, thereby increasing the diffusion efficiency of heavy rare earth elements from the diffusion source, which in turn enhances the coercivity of the magnet. Another approach utilizes a dual alloy method for the preparation of substrate magnets, which eliminates the hindrance of CeFe₂ diffusion at the triangular grain boundaries of the magnet, thus improving the diffusion efficiency of heavy rare earth elements within the magnet and ultimately increasing its coercivity.

However, both methods described above involve high-temperature grain boundary diffusion, which may lead to the accumulation of heavy rare earth elements within the primary phase grains. This phenomenon could result in low diffusion efficiency, preventing a significant increase in the coercivity of the magnet while also adversely affecting the squareness of the magnet.

### SUMMARY

The present disclosure aims to provide a cerium (Ce)-containing neodymium-iron-boron (NdFeB) magnet, along with its preparation method and applications. The method described in this disclosure produces a Ce-containing NdFeB magnet that exhibits reduced remanence loss, high coercivity, and a high degree of squareness in the demagnetization curve.

The first aspect of the disclosure provides a cerium (Ce)-containing neodymium-iron-boron (NdFeB) magnet, which comprises thin-shell grains, reverse-shell grains, and thick-shell grains,
wherein, the heavy rare earth element (HRE) content in the core of the reverse-shell grains is greater than the HRE content in the shell, the HRE content in the shell of the thick-shell grains is greater than the HRE content in the core, the thickness of the shell of the reverse-shell grains and the thickness of the shell of the thick-shell grains are each greater than 2 micrometers (μm), the HRE content in the shell of the thin-shell grains is greater than the HRE content in the core, and the thickness of the shell of the thin-shell grains is less than 2 μm;
the HRE is selected from dysprosium (Dy) and/or terbium (Tb);
in the surface region of the Ce-containing NdFeB magnet, the ratio of the number of thin-shell grains (N₁) to the total number of grains (N) in the Ce-containing NdFeB magnet is greater than or equal to 70% (N₁/N≥0.7);
in the near-surface region of the Ce-containing NdFeB magnet, the ratio of the sum of the number of reverse-shell grains (N₂) and the number of thick-shell grains (N₃) to the total number of grains (N′) in the Ce-containing NdFeB magnet is less than or equal to 5% ((N₂+N₃)/N′≤0.05);
the surface region includes the surface of the Ce-containing NdFeB magnet and the region within 50 μm from the surface, and the near-surface region includes the region from 50 μm to 100 μm from the surface of the Ce-containing NdFeB magnet.

In some embodiments, the ratio of the number of thin-shell grains (N₁) to the total number of grains (N) is greater than or equal to 82% (N₁/N≥0.82).

In some embodiments, in the surface region of the Ce-containing neodymium-iron-boron (NdFeB) magnet, the average grain size of the thin-shell grains is less than or equal to 5 micrometers (μm); the heavy rare earth element (HRE) content in the core of the thin-shell grains is less than or equal to 2 weight percent (wt %).

In some embodiments, in the surface region of the Ce-containing NdFeB magnet, the average grain size of the reverse-shell grains is in the range of 5 to 10 μm; the thickness of the shell of the reverse-shell grains is in the range of 2 to 4 μm.

In some embodiments, in the surface region of the Ce-containing NdFeB magnet, the average grain size of the thick-shell grains is in the range of 5 to 10 μm; the thickness of the shell of the thick-shell grains is in the range of 2 to 4 μm.

In some embodiments, the Ce-containing NdFeB magnet comprises RL, Ce, M, B, HRE, and T, wherein, RL is selected from one or more elements of Nd, Pr, La, Y, Ho, and Gd, and must include Nd and/or Pr; M is selected from one or more elements of Al, Cu, Ga, Cr, Ti, and Zr; T is Fe and/or Co; the content of RL in the Ce-containing NdFeB magnet is in the range of 19 to 28 wt %, the content of Ce is in the range of 4 to 13 wt %, the content of M is in the range of 0.1 to 2.0 wt %, the content of B is in the range of 0.9 to 1.0 wt %, the content of HRE is in the range of 0.2 to 0.8 wt %, with the remainder being T.

The second aspect of the present disclosure provides a method for preparing a Ce-containing neodymium-iron-boron (NdFeB) magnet, which comprises:
compacting Ce-RL1-T-B-M alloy powder and sintering to obtain a base alloy, where RL1 is selected from one or more elements of Nd, Pr, La, Y, Ho, Gd, Dy, and Tb, and must include Nd and/or Pr; M is selected from one or more elements of Al, Cu, Ga, Cr, Ti, and Zr; and T is Fe and/or Co;
attaching a heavy rare earth (HRE) containing film to the surface of the base alloy, wherein the HRE is selected from Dy and/or Tb;
subjecting the base alloy with the attached HRE-containing film to diffusion treatment and tempering treatment to obtain the Ce-containing NdFeB magnet;
wherein, the diffusion treatment comprises a first stage diffusion treatment and a second stage diffusion treatment;
the temperature for the first stage diffusion treatment is in the range of 750 to 890° C., with a holding time of 1.5 to 4 hours;
the temperature for the second stage diffusion treatment is in the range of 900 to 950° C., with a holding time of 1.5 to 4.5 hours.

In some embodiments, the method further includes cooling the base alloy with the attached HRE-containing film prior to the second stage diffusion treatment.

In some embodiments, the temperature for the first stage diffusion treatment is in the range of 810 to 850° C.

In some embodiments, the method of attaching the HRE-containing film to the surface of the base alloy includes using vacuum deposition, magnetron sputtering, slurry coating, immersion, screen printing, roller coating, or spraying to apply a diffusion source containing HRE onto the surface of the base alloy to form the film; the thickness of the film is in the range of 5 to 30 μm, where the diffusion source is selected from one or more metals, alloys, or compounds containing HRE.

In some embodiments, in the Ce-RL1-T-B-M alloy powder, the content of Ce is in the range of 4 to 13 wt %, the content of RL1 is in the range of 19 to 28 wt %, the content of M is in the range of 0.1 to 2.0 wt %, the content of B is in the range of 0.9 to 1.0 wt %, with the balance being T.

In some embodiments, the method further includes the step of preparing Ce-RL1-T-B-M alloy strips using a rapid solidification process, followed by conducting hydrogen crushing treatment and micro-pulverization treatment to obtain the Ce-RL1-T-B-M alloy powder where the D50 particle size of the Ce-RL1-T-B-M alloy powder is in the range of 3 to 5.5 μm.

In some embodiments, the compacting process is an orientation compacting process, conducted under a magnetic induction intensity of 1.5 to 2.0 T; the sintering process is carried out at a temperature of 1010 to 1050° C. with a holding time of 2 to 6 hours; the tempering process is conducted at a temperature of 480 to 640° C. with a holding time of 1 to 4 hours.

The third aspect of the present disclosure provides a Ce-containing neodymium-iron-boron (NdFeB) magnet prepared using the method described in the second aspect of the disclosure.

Through the above technical solutions, the present disclosure employs a staged diffusion process at different temperatures to treat the surface-attached heavy rare earth (HRE) film on the substrate alloy. The first-stage diffusion treatment is conducted at a temperature range of 750 to 890° C., effectively controlling the rate at which HRE heavy rare earth elements diffuse into the substrate alloy. This results in a significant formation of uniformly distributed shell-layered grains within the surface region of the substrate alloy (within 50 μm from the surface).

Subsequently, the substrate alloy after the first diffusion treatment is cooled and subjected to a second-stage diffusion treatment at a temperature range of 900 to 950° C., which increases the HRE diffusion rate, further forming more uniformly distributed shell-layered grains in the surface region of the magnet, with clearer shell structures. The large number of uniformly distributed shell-layered grains in the surface region of the magnet effectively reduces the number of thick-shell grains and reverse-shell grains in this area and lowers the content of HRE heavy rare earth elements in the surface and near-surface regions.

The staged diffusion process allows for control over the rate of HRE heavy rare earth elements entering the substrate alloy, thus effectively suppressing the generation and growth of reverse-shell grains and reducing the grain size in the surface and near-surface regions. This is beneficial for the uniform distribution of heavy rare earth elements in the magnet, decreasing their concentration in the core of the grains. The Ce-containing neodymium-iron-boron magnets prepared according to the present disclosure have a high proportion of shell-layered grains in the surface region, while the proportion of reverse-shell and thick-shell grains in the near-surface region is low.

The resulting Ce-containing NdFeB magnets exhibit minimal reduction in remanence, and show significant improvements in coercivity and squareness of the demagnetization curve, demonstrating excellent magnetic performance.

Other features and advantages of the present disclosure will be described in detail in the following specific embodiment section.

### BRIEF DESCRIPTION OF DRAWINGS

The figures included in this disclosure are provided to enhance the understanding of the present disclosure. The illustrative embodiments and their descriptions herein are intended to elucidate the present disclosure and do not impose any undue limitations thereon.

FIG. 1 is a scanning electron microscope (SEM) image of the substrate alloy sample after the first-stage diffusion treatment in Example 1 of the present disclosure, where (a) and (b) respectively show SEM images of the 0 to 100 μm regions from the diffusion surface in two different observation cross-sections of the sample.

FIG. 2 is a SEM image of the Ce-containing neodymium-iron-boron (NdFeB) magnet CT-1 from Example 1 of the present disclosure, where (a) and (b) respectively show SEM images of the 0 to 100 μm regions from the diffusion surface in two different observation cross-sections of the magnet.

FIG. 3 is an SEM image of the comparative sample DCT-1 of the Ce-containing neodymium-iron-boron magnet in Comparative Example 1 of the present disclosure, where (a) and (b) respectively show SEM images of the 0 to 100 μm regions from the diffusion sample surface in two different observation cross-sections of the magnet.

FIG. 4 is an SEM image of the substrate alloy used in Example 1 of the present disclosure.

FIG. 5 is a schematic diagram illustrating the grain distribution in the surface region of the magnets after diffusion for Comparative Example 1 and Example 1 of the present disclosure.

### DETAILED DESCRIPTION OF EMBODIMENTS

The following detailed description of specific embodiments of the present disclosure is made in conjunction with the accompanying drawings. It should be understood that the specific embodiments described herein are for illustrative and explanatory purposes only and are not intended to limit the scope of the present disclosure.

The first aspect of the disclosure provides a cerium (Ce)-containing neodymium-iron-boron (NdFeB) magnet, which comprises thin-shell grains, reverse-shell grains, and thick-shell grains,
wherein, the heavy rare earth element (HRE) content in the core of the reverse-shell grains is greater than the HRE content in the shell, the HRE content in the shell of the thick-shell grains is greater than the HRE content in the core, the thickness of the shell of the reverse-shell grains and the thickness of the shell of the thick-shell grains are each greater than 2 micrometers (μm), the HRE content in the shell of the thin-shell grains is greater than the HRE content in the core, and the thickness of the shell of the thin-shell grains is less than 2 μm;
the HRE is selected from dysprosium (Dy) and/or terbium (Tb);
in the surface region of the Ce-containing NdFeB magnet, the ratio of the number of thin-shell grains (N₁) to the total number of grains (N) in the Ce-containing NdFeB magnet is greater than or equal to 70% (N₁/N≥0.7);
in the near-surface region of the Ce-containing NdFeB magnet, the ratio of the sum of the number of reverse-shell grains (N₂) and the number of thick-shell grains (N₃) to the total number of grains (N′) in the Ce-containing NdFeB magnet is less than or equal to 5% ((N₂+N₃)/N′≤0.05);

the surface region includes the surface of the Ce-containing NdFeB magnet and the region within 50 μm from the surface, and the near-surface region includes the region from 50 μm to 100 μm from the surface of the Ce-containing NdFeB magnet.

The Ce-containing neodymium-iron-boron (NdFeB) magnet provided by the present disclosure has a uniform grain distribution in the surface layer region (surface region and near-surface region) thereof, with a high proportion of thin-shell grains in the surface region, a smaller average grain size, and a lower content of heavy rare earth elements in the core of the thin-shell grains. In the near-surface region of the magnet, the proportion of reverse-shell grains and thick-shell grains is low, and the grain sizes of both are effectively suppressed. As a result, the Ce-containing NdFeB magnet provided by the present disclosure exhibits minimal remanence decline, high coercivity, and high demagnetization curve squareness, demonstrating excellent magnetic performance.

In the aforementioned embodiment, the present disclosure allows for a higher proportion of thin-shell grains in the surface region of the Ce-containing NdFeB magnet, while the central region of the magnet has a lower proportion of reverse-shell grains and thick-shell grains. This leads to reduced remanence decline, further enhancing coercivity and demagnetization curve squareness, resulting in superior magnet performance.

In this disclosure, the N₁/N ratio of the Ce-containing NdFeB magnet can be represented by the average N₁/N values obtained from multiple cross-sections in the surface region of the magnet. Specifically, multiple different cross-sections within the surface region of the magnet can be randomly selected to measure the N₁/N value, and the average of these N₁/N values from the different cross-sections represents the N₁/N value in the surface region of the magnet. Similarly, the (N₂+N₃)/N′ value of the Ce-containing NdFeB magnet can be represented by the average results of the (N₂+N₃)/N′ values from multiple cross-sections in the near-surface region, which can also be determined by randomly selecting different cross-sections in the near-surface region to measure the (N₂+N₃)/N′ value. The average of these (N₂+N₃)/N′ values from the different cross-sections represents the (N₂+N₃)/N′ value in the near-surface region of the magnet.

In one specific embodiment, the average grain size of the thin-shell grains in the surface region of the Ce-containing NdFeB magnet is less than 5 μm.

The present disclosure provides a uniform distribution of a large number of thin-shell grains in the surface region, with a small average grain size, significantly enhancing the performance of the magnet.

In another specific embodiment, the heavy rare earth (HRE) content in the core of the thin-shell grains in the surface region of the Ce-containing NdFeB magnet is less than 2 wt %.

In this disclosure, the low content of heavy rare earth elements in the core of the thin-shell grains, with heavy rare earth elements mainly concentrated in the shell of the thin-shell grains, ensures that the magnet maintains high coercivity while exhibiting minimal remanence decline and high demagnetization curve squareness.

In another specific embodiment, the average grain size of the reverse-shell grains in the surface region of the Ce-containing NdFeB magnet is between 5 and 10 μm, and the thickness of the shell of the reverse-shell grains is between 2 and 4 μm.

In another specific embodiment, the average grain size of the thick-shell grains in the surface region of the Ce-containing NdFeB magnet is also between 5 and 10 μm, and the thickness of the shell of the thick-shell grains is between 2 and 4 μm.

In this disclosure, a large number of uniformly distributed thin-shell grains are formed in the surface layer region of the magnet, effectively controlling the quantity and average grain size of the reverse-shell grains and thick-shell grains in the surface region.

In another specific embodiment, the Ce-containing NdFeB magnet includes RL, Ce, M, B, HRE, and T, where RL is selected from one or more elements from Nd, Pr, La, Y, Ho, and Gd, with RL including Nd and/or Pr, and M is selected from one or more elements from Al, Cu, Ga, Cr, Ti, and Zr. T is Fe and/or Co.

In another specific embodiment, the content of RL in the Ce-containing NdFeB magnet is between 19 and 28 wt %, the Ce content is between 4 and 13 wt %, the M content is between 0.1 and 2.0 wt %, In some embodiments between 0.2 and 2.0 wt %, the B content is between 0.9 and 1.0 wt %, the HRE content is between 0.2 and 0.8 wt %, with the remainder being T.

The second aspect of the present disclosure provides a method for preparing a Ce-containing neodymium-iron-boron (NdFeB) magnet, which comprises:
compacting Ce-RL1-T-B-M alloy powder and sintering to obtain a base alloy, where RL1 is selected from one or more elements of Nd, Pr, La, Y, Ho, Gd, Dy, and Tb, and RL1 must include Nd and/or Pr; M is selected from one or more elements of Al, Cu, Ga, Cr, Ti, and Zr; and T is Fe and/or Co;
attaching a heavy rare earth (HRE) containing film to the surface of the base alloy, which HRE is selected from Dy and/or Tb;
subjecting the base alloy with the attached HRE-containing film to diffusion treatment and tempering treatment to obtain the Ce-containing NdFeB magnet;
wherein, the diffusion treatment comprises a first stage diffusion treatment and a second stage diffusion treatment;
the temperature for the first stage diffusion treatment is in the range of 750 to 890° C., with a holding time of 1.5 to 4 hours;
the temperature for the second stage diffusion treatment is in the range of 900 to 950° C., with a holding time of 1.5 to 4.5 hours.

Specifically, the diffusion treatment includes heating the base alloy with the attached HRE-containing film under vacuum to the first stage diffusion treatment temperature, followed by cooling in a protective gas after the holding period of the first stage diffusion treatment. Once cooled to 10 to 40° C., the temperature is then increased under vacuum to the second stage diffusion treatment temperature. After the holding period of the second stage diffusion treatment, cooling is conducted in a protective gas until room temperature is reached. The protective gas may be argon, nitrogen, or the like.

The methods for attaching a film containing heavy rare earth (HRE) elements to the surface of the substrate alloy include employing vacuum deposition, magnetron sputtering, slurry coating, immersion, screen printing, roll coating, and spraying techniques to attach a diffusion source containing HRE to the surface of the substrate alloy, thereby forming a film. The diffusion source is selected from one or more of the metals, alloys, or compounds containing HRE. The thickness of the film is between 5 and 30 μm.

During the grain boundary diffusion process, at a higher diffusion temperature (900-950° C.), the diffusion rate of heavy rare earth elements is beneficially increased. However, due to the more active primary phase grains in cerium-containing substrate alloys as compared to those in praseodymium-neodymium substrate alloys, at elevated diffusion temperatures, cerium atoms in the primary phase grains in the surface layer region of the substrate alloy can be easily substituted by HRE atoms, allowing dysprosium (Dy) or terbium (Tb) to enter the interiors of the primary phase grains, leading to enrichment within the primary phase grains and resulting in an increased number of reverse-shell grains (where the HRE content in the core of the primary phase grain is higher than that in the shell, with a shell thickness exceeding 2 μm) in the surface layer region. Additionally, thick-shell grains (where the HRE content in the shell of the primary phase grain is higher than that in the core, with a shell thickness exceeding 2 μm) are also likely to occur. Compared to thin-shell grains, the shell thickness and average grain size of the reverse-shell grains and thick-shell grains are larger. The increase in the number of inverse shell grains and thick-shell grains in the surface layer region of the magnet is unfavorable for improving the squareness of the demagnetization curve and the coercivity of the magnet.

This disclosure proposes a staged diffusion process for treating the substrate alloy with the attached film containing HRE. The substrate alloy undergoes a first-stage diffusion treatment at a temperature of 750-890° C., which effectively controls the rate at which heavy rare earth elements from the diffusion source enter the interior of the substrate alloy. This treatment allows for the formation of a clear and uniform thin-shell grain structure in the surface region within 50 m of the magnet surface, effectively reducing the number of inverse shell grains in the near-surface region of the magnet and the concentration of heavy rare earth elements at the surface region of the substrate alloy. Subsequently, the substrate alloy, after being cooled from the first-stage diffusion treatment, undergoes a second-stage diffusion treatment at a temperature of 900-950° C., which further promotes the diffusion of heavy rare earth elements, resulting in a larger number of uniformly distributed thin-shell grains and a smaller average grain size in the surface region. This further effectively suppresses the formation and growth of reverse-shell grains, thereby optimizing the distribution of heavy rare earth elements in the magnet and reducing their concentration in the core of the primary phase grains.

The magnets prepared according to this disclosure, which contain cerium-containing neodymium-iron-boron, exhibit a high proportion of thin-shell grains in the surface region, with a reduced proportion of inverse shell grains and thick-shell grains in the near-surface region. Consequently, the remanence decline of these cerium-containing neodymium-iron-boron magnets is minimal, and both the coercivity and the squareness of the demagnetization curve show significant improvements, resulting in excellent magnetic performance.

In one specific embodiment, the temperature of the first-stage diffusion treatment is set between 810° C. and 850° C. By controlling the temperature of the first-stage diffusion treatment within this range, the rate at which heavy rare earth elements (HRE) from the diffusion source enter the diffusion surface can be further effectively controlled, leading to an increased number of thin-shell grains in the surface region of the cerium-containing neodymium-iron-boron magnet. The resulting thin-shell grains will have a more uniform shell structure, which can further reduce the number of inverse shell grains and thick-shell grains in the central region of the magnet.

In another specific embodiment, the method of attaching a film containing HRE to the surface of the substrate alloy includes using vacuum deposition, magnetron sputtering, slurry coating, immersion, screen printing, roll coating, or spraying techniques to attach a diffusion source containing HRE to the surface of the substrate alloy, thereby forming the film. The diffusion source is selected from one or more metals, alloys, or compounds containing HRE, and the thickness of the film is between 5 and 30 μm.

In a further specific embodiment, the Ce-RL1-T-B-M alloy powder contains 4-13 wt % of Ce, 19-28 wt % of RL1, 0.1-2.0 wt % of M, 0.9-1.0 wt % of B, with the balance being T.

In another specific embodiment, the method further includes the steps of preparing a Ce-RL1-T-B-M alloy sheet using a rapid solidification process, and subjecting the Ce-RL1-T-B-M alloy sheet to hydrogen crushing and fine powder grinding processes to obtain the Ce-RL1-T-B-M alloy powder; the average particle size D50 of the Ce-RL1-T-B-M alloy powder is between 3 and 5.5 μm.

In this disclosure, compacting, sintering treatment, diffusion treatment, and tempering treatment can utilize conventional apparatus known in the art.

In one embodiment, the fine powder grinding is performed in an air jet mill, with the grinding pressure of the air jet mill set between 0.5 and 0.9 MPa.

In another specific embodiment, compacting is carried out under a magnetic field with the magnetic induction strength between 1.5 T and 2.0 T; the sintering treatment is performed at a temperature of 1010° C. to 1050° C., with a holding time of 2 to 4 hours; and the tempering treatment is conducted at a temperature of 480° C. to 640° C., with a holding time of 1 to 4 hours.

The third aspect of the present disclosure provides a cerium-containing neodymium-iron-boron magnet produced using the method described in the second aspect of the disclosure.

### Example 1

Preparation process of the Ce-containing neodymium-iron-boron (NdFeB) magnet in the present disclosure is as follow.

Preparing Ce-RL1-T-B-M alloy powder: the alloy raw material with a mass percentage configuration of (PrNd)_{25.6}Ce_{5.6}Fe_{bal}Co_{0.3}Al_{0.25}Cu_{0.15}Ga_{0.05}B_{0.92} is prepared and cast into a rapidly quenched thin strip using a rapid solidification process which the surface linear speed of the rollers during the rapid solidification process is set at 1.0 to 1.2 m/s, and the casting temperature is maintained at 1480° C., resulting in a thin strip thickness of 0.1 to 0.6 mm; the rapidly quenched thin strip undergoes HD hydrogen explosion treatment, followed by hydrogen saturation and dehydrogenation at 540° C. for 6 hours, achieving a hydrogen content of 1200 ppm and yielding coarsely crushed powder; the coarsely crushed powder is then milled using an airflow mill, with a grinding pressure of 0.6 MPa, resulting in a Ce-RL1-T-B-M alloy powder with an average particle size (D50) of 4.5 μm.

Compacting and sintering the alloy powder: the obtained Ce-RL1-T-B-M alloy powder undergoes compacting and sintering treatments to produce a substrate alloy where the compacting treatment is an oriented compacting process conducted under N₂ gas protection, with an orientation magnetic induction intensity of 1.8 T and the sintering treatment is performed at a temperature of 1030° C. for a holding time of 1.5 hours.

Processing the substrate alloy into samples: the substrate alloy is processed into samples with dimensions of 4 mm (oriented direction)×9 mm (longitudinal)×9 mm (transverse); a Tb metal target is used to perform magnetron sputtering on the surface of the processed substrate alloy samples, which are oriented perpendicular to the magnetization direction; the samples then undergo vacuum diffusion treatment and vacuum tempering treatment to obtain a CeNdFeB magnet, designated as CT-1. During the magnetron sputtering treatment, a Tb film is formed on the surface of the substrate, with an average thickness of 8 μm. The diffusion treatment consists of a first-stage diffusion treatment and a second-stage diffusion treatment. Specifically, the substrate alloy with the Tb film on its surface is heated in a vacuum to the first-stage diffusion treatment temperature of 830° C., with a holding time of 4 hours. After holding, argon gas is introduced for cooling to room temperature, followed by vacuum heating to the second-stage diffusion treatment temperature of 950° C., with a holding time of 1.5 hours, after which argon gas is again introduced for cooling. The tempering treatment process involves heating the substrate alloy sample, after diffusion treatment, in a vacuum to the tempering treatment temperature of 550° C., with a holding time of 1 hour, followed by cooling to room temperature with argon gas, resulting in a CeNdFeB magnet.

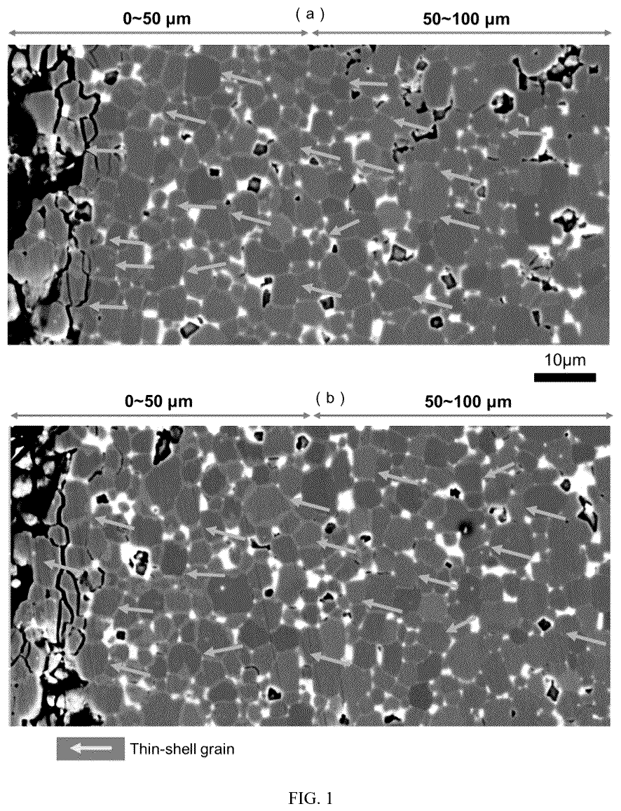

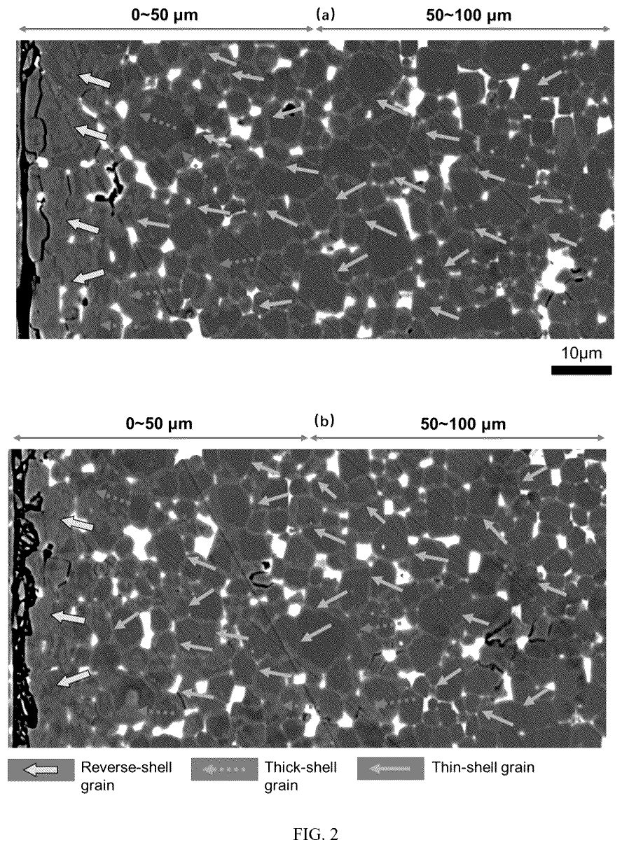

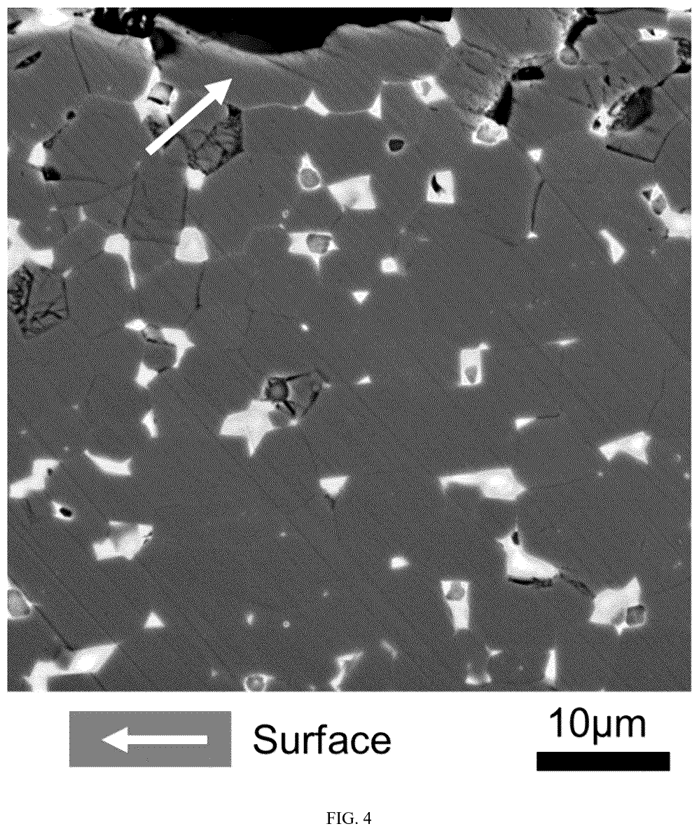

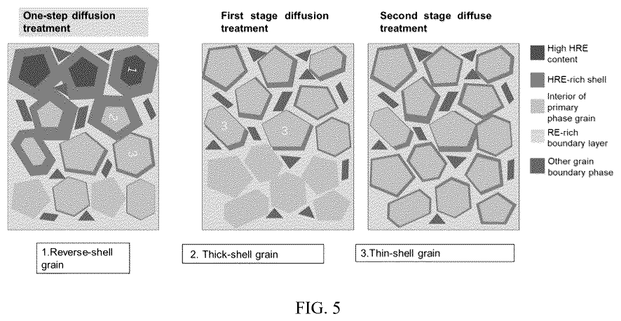

SEM (scanning electron microscopy) analyses are performed on the substrate alloy, the sample after the first-stage diffusion treatment, and the resulting magnet CT-1, with results shown in FIGS. 1, 2, and 4, respectively. The observation surfaces are sections of the substrate or magnet parallel to the magnet's orientation direction, starting from the surface of the substrate/magnet where the HRE film is attached (i.e., the diffusion surface). In FIGS. 1 and 2, the left end of the images shows the diffusion surface of the substrate/magnet, while the top end of FIG. 4 illustrates the diffusion surface of the substrate. The middle and right images in FIG. 5 depict schematic diagrams of the grain distribution within the surface regions of the substrate alloy after the first diffusion treatment and the magnet after the second diffusion treatment, respectively.

From FIGS. 1, 4, and 5, it can be observed that after the first diffusion treatment, the surface region of the substrate alloy sample (0-50 μm from the surface) exhibits uniform grain sizes, primarily consisting of grains with a thin shell structure thickness of 0.5 to 2.0 μm. The average grain size of all grains in the surface region shows almost no change compared to the average grain size of the substrate. Thus, it is evident that there is no significant grain growth after the first-stage diffusion heat treatment, with very few inverse shell grains present.

From FIG. 2, it can be seen that after the two-stage diffusion treatment and tempering process, the surface region of the substrate alloy exhibits only surface region grains and thick core-shell grains. The average grain size of all grains shows a relatively small growth compared to the average grain size of the substrate grains.

### Example 2

Referring to the preparation method in Example 1, the difference in this example is that in step S3, the temperature for the first-stage diffusion treatment is set at 750° C. with a holding time of 1.5 hours, resulting in a Ce—Nd—Fe—B magnet designated as CT-2.

### Example 3

Referring to the preparation method in Example 1, the difference in this example is that in step S3, the temperature for the first-stage diffusion treatment is set at 890° C. with a holding time of 1.5 hours, resulting in a Ce—Nd—Fe—B magnet designated as CT-3.

### Example 4

Preparing Ce-RL1-T-B-M alloy powder through the following steps.

Formulating alloy raw materials with the mass percentage wt % of (PrNd)_{19.5}Ce₁₁Fe_{bal}Co_{0.3}Al_{0.25}Cu_{0.15}Ga_{0.05}B_{0.92}, and casting the formulated alloy raw materials into a rapidly solidified thin strip using a rapid solidification process; wherein the surface linear speed of the roller in the rapid solidification process is between 1 to 1.2 m/s, the pouring temperature in the rapid solidification process is 1500° C., and the thickness of the rapidly solidified thin strip is between 0.1 to 0.6 mm. Conducting HD hydrogen explosion treatment on the rapidly solidified thin strip, saturating it with hydrogen and then dehydrating at 540° C. for 6 hours, resulting in a hydrogen content of 1200 ppm after dehydration, thereby obtaining coarse powder. Processing the coarse powder using an airflow mill, with a grinding pressure of 0.6 MPa, resulting in Ce-RL1-T-B-M alloy powder with an average particle size D50 of 4.5 μm.

Subjecting the obtained Ce-RL1-T-B-M alloy powder to forming treatment and sintering treatment to obtain the substrate alloy; wherein the forming treatment is an orientation forming treatment conducted under N₂ gas protection with an orientation magnetic induction intensity of 1.8 T; the sintering treatment is performed at a temperature of 1030° C. with a holding time of 1.5 hours.

Machining the substrate alloy into samples of thickness (in the orientation direction) 4 mm×longitudinal 9 mm×transverse 9 mm, applying a slurry containing Dy metal powder to the surface of the substrate alloy, followed by diffusion treatment and tempering treatment, resulting in a Ce—Nd—Fe—B magnet designated as CT-4. The Dy metal powder coating on the substrate surface has an average thickness of 20 μm, with an average particle size of 4.5 μm and a content of 80 wt % in the slurry; the diffusion treatment comprises a first-stage diffusion treatment and a second-stage diffusion treatment, wherein the first-stage diffusion treatment is conducted at a temperature of 830° C. with a holding time of 4 hours, and the second-stage diffusion treatment is conducted at a temperature of 950° C. with a holding time of 4.5 hours; the tempering treatment is performed at a temperature of 550° C. with a holding time of 1 hour.

### Comparative Example 1

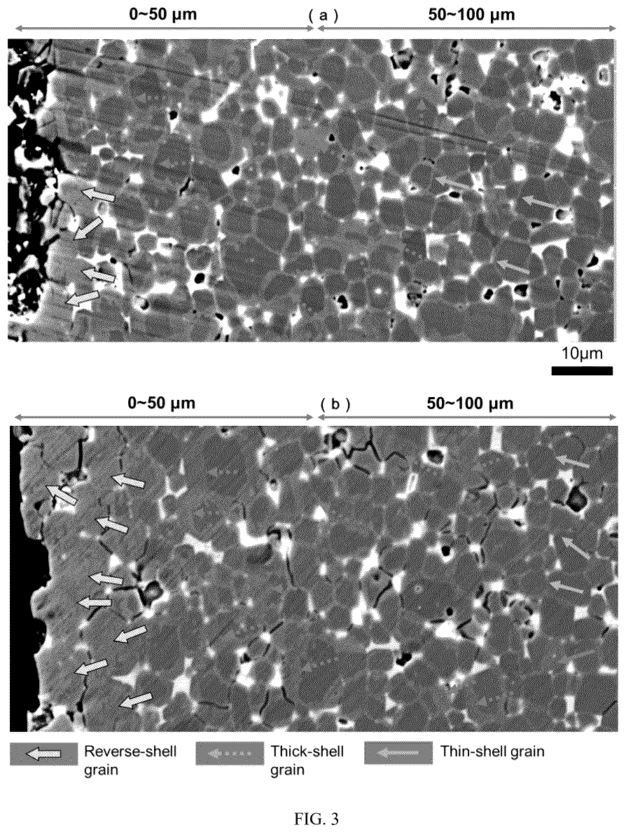

Referring to the preparation method in Example 1, the difference from Example 1 is that in step: the diffusion treatment is conducted at a temperature of 950° C. for a holding time of 1.5 hours, resulting in a Ce-containing NdFeB magnet, denoted as DCT-1. The obtained magnet DCT-1 is subjected to SEM analysis, with the results shown in FIG. 3. In FIGS. 3(a) and (b), the arrows indicate the surface region (0-50 μm from the sample surface) and the near-surface region (50-100 μm from the sample surface).

The left side of FIG. 5 illustrates a schematic diagram of the grain distribution in the surface region of the magnet after the one-step diffusion treatment in Comparative Example 1. A large number of reverse-shell grains (with heavy rare earth element accumulation inside the grains) and thick-shell grains are observed on the surface. From FIGS. 3 and 5, it can be seen that after the diffusion treatment at 950° C. for 1.5 hours and the subsequent annealing treatment at 550° C. for 1 hour, the number of reverse-shell and thick-shell grains in the sample is relatively high. The average grain size has increased significantly compared to the substrate, indicating that using only a single-step diffusion heat treatment is not effective in suppressing grain growth.

### Comparative Example 2

Referring to the preparation method in Example 4, the difference from Example 4 is that in step S3, the diffusion treatment is conducted at a temperature of 950° C. for a holding time of 4.5 hours, resulting in a Ce-containing NdFeB magnet, denoted as DCT-2.

### TEST EXAMPLES

The compositions of the Ce-containing NdFeB magnet samples prepared in Examples 1-4 and Comparative Examples 1-2 are tested using an ICP composition analyzer, with the results listed in Table 1. The microstructure of the substrate alloy, the substrate alloy after the first diffusion treatment, and the magnet samples after the second diffusion treatment are analyzed using SEM, with the results shown in FIGS. 1-3. The observation surfaces are cross-sections of the substrate or magnet parallel to the orientation direction.

The grain quantity, size, and distribution of the substrate/magnet are tested using the following method and statistically analyzed using IPP (Image-Pro Plus) image analysis software. For each substrate/magnet to be tested, five random cross-sections are selected, and for each cross-section, a 50 μm×100 μm area is randomly selected at a magnification of 2000×, including a 50 μm×50 μm surface region (0-50 μm from the surface) and a 50 μm×50 μm near-surface region (50-100 μm from the surface). The analysis includes the heavy rare earth element content in the core and shell regions of the magnet surface, the shell thickness, as listed in Table 2, and the determination of grain types in the surface and near-surface regions of the magnet.

In FIGS. 1 to 3, the regions with darker grain contrast (black) represent the core area, while the areas with lighter grain contrast (gray) correspond to the shell area. The shell thickness is defined as the width of the shell region between two adjacent grains.

For each cross-section, the number of thin-shell grains in the 50 μm×50 μm surface region is denoted as N₁, while the total number of magnet grains in the surface region is denoted as N. In the 50 μm×50 μm near-surface region, the number of reverse-shell grains is denoted as N₂, the number of thick-shell grains is denoted as N₃, and the total number of magnet grains in the near-surface region is denoted as N′. The average values of N₁/N and (N₂+N₃)/N′ are calculated across multiple cross-sections and are reported as the N₁/N value and (N₂+N₃)/N′ value for the magnet in Table 2. Notably, incomplete grains within a given region are also included in the corresponding grain count.

The average grain size (1) of the surface region of the Ce-containing NdFeB magnets and the average grain sizes (2) of different grain types are obtained through statistical analysis using the IPP (Image-Pro Plus) image analysis software. The magnetic performance test results for the Ce-containing NdFeB magnets prepared in Examples 1-4 and Comparative Examples 1-2 are listed in Table 3.

TABLE 1

| | | | | M (Al, | | | Average |
|---|---|---|---|---|---|---|---|
| | | | Tb/ | Cu, Cr, | | Fe, | Grain |
| | PrNd/ | Ce/ | Dy/ | Ga, Zr)/ | B/ | Co/ | Size |
| No. | wt % | wt % | wt % | wt % | wt % | wt % | (1)/μm |
| Substrate | 24.37 | 5.37 | 0 | 0.58 | 0.96 | Balance | 4.36 |
| Example 1 | | | | | | | 4.38 |
| (after first | | | | | | | |
| diffusion | | | | | | | |
| treatment) | | | | | | | |
| Example 1 | 24.63 | 5.31 | 0.48 | 0.62 | 0.94 | Balance | 4.54 |
| Example 2 | 24.54 | 5.45 | 0.51 | 0.61 | 0.94 | Balance | 4.51 |
| Example 3 | 24.37 | 5.38 | 0.49 | 0.61 | 0.95 | Balance | 5.06 |
| Example 4 | 19.16 | 10.73 | 0.55 | 0.49 | 0.93 | Balance | 4.46 |
| Comparative | 24.49 | 5.42 | 0.50 | 0.59 | 0.94 | Balance | 5.36 |
| Example 1 | | | | | | | |
| Comparative | 19.21 | 10.67 | 0.53 | 0.58 | 0.93 | Balance | 5.42 |
| Example 2 | | | | | | | |

(Note: “Balance” refers to the remaining percentage of elements not specified in the table. The average grain size (1) is the mean value of all grain sizes within the surface region of the cross-section (the region 0 to 50 μm from the surface)

TABLE 2

| | | Heavy Rare | Heavy Rare | | | | |
|---|---|---|---|---|---|---|---|
| | | Earth Element | Earth Element | | | | |
| | | Content in | Content in | Average | | | |
| | Different | Grain Shell/ | Grain Core/ | Grain Size | Shell | | (N₂ + |
| Magnet | Grain Types | wt % | wt % | (2)/μm | Thickness/μm | N₁/N | N₃)/N′ |
| Example 1 | Reverse- | 5~10 | 12~15 | 6.95 | 2~4 | 90.2% | 2.8% |
| | shell grains | | | | | | |
| | Thick- | 5~10 | 0~2 | 5.87 | 2~4 | | |
| | shell grains | | | | | | |
| | Thin- | 3~7 | 0~2 | 4.37 | 0.5~2.0 | | |
| | shell grains | | | | | | |
| Example 2 | Reverse- | 5~10 | 12~15 | 6.88 | 2~4 | 87.1% | 3.5% |
| | shell grains | | | | | | |
| | Thick- | 5~10 | 0~2 | 5.62 | 2~4 | | |
| | shell grains | | | | | | |
| | Thin- | 3~7 | 0~2 | 4.41 | 0.5~2.0 | | |
| | shell grains | | | | | | |
| Example 3 | Reverse- | 5~10 | 12~15 | 7.21 | 2~4 | 79.2% | 4.2% |
| | shell grains | | | | | | |
| | Thick- | 5~10 | 0~2 | 6.11 | 2~4 | | |
| | shell grains | | | | | | |
| | Thin- | 3~7 | 0~2 | 4.47 | 0.5~2.0 | | |
| | shell grains | | | | | | |
| Example 4 | Reverse- | 5~10 | 12~15 | 6.84 | 2~4 | 88.7% | 2.9% |
| | shell grains | | | | | | |
| | Thick- | 5~10 | 0~2 | 5.73 | 2~4 | | |
| | shell grains | | | | | | |
| | Thin- | 3~7 | 0~2 | 4.40 | 0.5~2.0 | | |
| | shell grains | | | | | | |
| Comparative | Reverse- | 5~10 | 12~15 | 9.50 | 2~4 | 26.8% | 25.6% |
| Example 1 | shell grains | | | | | | |
| | Thick- | 5~10 | 0~2 | 6.35 | 2~4 | | |
| | shell grains | | | | | | |
| | Thin- | 3~7 | 0~2 | 4.52 | 0.5~2.0 | | |
| | shell grains | | | | | | |
| Comparative | Reverse- | 5~10 | 12~15 | 9.60 | 2~4 | 25.2% | 29.6% |
| Example 2 | shell grains | | | | | | |
| | Thick- | 5~10 | 0~2 | 6.87 | 2~4 | | |
| | shell grains | | | | | | |
| | Thin- | 3~7 | 0~2 | 4.38 | 0.5~2.0 | | |
| | shell grains | | | | | | |

Note:
The average grain size (2) is the mean value of different primary phase grain sizes within the surface region of the cross-section (the region 0 to 50 μm from the surface).

TABLE 3

| | Remanence | Coercivity | |
|---|---|---|---|
| Samples | Br/kGs | HCJ/kOe | Hk/HCJ |
| Substrate | 13.60 | 13.90 | 0.97 |
| CT-1 | 13.40 | 20.15 | 0.96 |
| CT-2 | 13.38 | 17.55 | 0.95 |
| CT-3 | 13.32 | 19.23 | 0.93 |
| CT-4 | 12.44 | 16.23 | 0.96 |
| DCT-1 | 13.42 | 19.43 | 0.89 |
| DCT-2 | 12.38 | 15.19 | 0.91 |

The data presented in Table 3 demonstrates that the disclosed method employs a staged diffusion process at varying temperatures to treat a substrate alloy coated with a surface-attached film containing heavy rare earth (TIRE) elements. The first stage of diffusion is conducted at temperatures ranging from 750° C. to 890° C., effectively controlling the rate at which TIRE heavy rare earth elements diffuse into the substrate alloy. This process facilitates the formation of uniformly distributed thin-shell grains in the surface region of the substrate alloy (including the surface of the Ce—Nd—Fe—B magnet and the cross-sectional region within 50 μm of the surface).

Following the first diffusion treatment, the substrate alloy is cooled and subjected to a second stage of diffusion at temperatures between 900° C. and 950° C. During this stage, the diffusion rate of HRE elements increases, leading to the formation of an even greater number of uniformly distributed thin-shell grains in the surface region of the magnet. The resulting thin-shell grains exhibit clearer shell structures and are abundantly distributed within the surface region of the magnet. This approach effectively reduces the number of thick-shell grains and reverse-shell grains within the surface and near-surface regions, while also significantly lowering the concentration of HRE heavy rare earth elements in these areas.

Moreover, the staged diffusion process effectively inhibits the formation and growth of reverse-shell grains, resulting in a reduction in grain size within the surface and near-surface regions of the magnet. This is advantageous for achieving a uniform distribution of heavy rare earth elements within the magnet, thereby decreasing their concentration in the core of the grains. The thin-shell grains produced in the surface region of the disclosed Ce—Nd—Fe—B magnet exhibit a high proportion, while the quantities of reverse-shell and thick-shell grains in the near-surface region are minimized. The disclosed method results in a Ce—Nd—Fe—B magnet with minimal reduction in remanence, significantly enhanced coercivity, and improved squareness of the demagnetization curve, demonstrating superior magnetic performance.

Comparing Examples 2 and 3 with Example 1 reveals that controlling the temperature of the first-stage diffusion treatment to an optimized range of 810° C. to 850° C. further effectively regulates the rate at which HRE heavy rare earth elements from the diffusion source enter the diffusion surface. This adjustment increases the number of thin-shell grains in the surface region of the Ce—Nd—Fe—B magnet and results in more uniform shell structures for these grains. Consequently, the quantities of reverse-shell and thick-shell grains in the central region of the magnet are further reduced, thereby enhancing the coercivity and squareness of the prepared magnet.

The comparison between Comparative Example 1 and Embodiment 1, as well as between Comparative Example 2 and Embodiment 4, demonstrates that directly subjecting the substrate alloy with a coating to diffusion treatment at a high temperature of 950° C. makes it easier for Ce atoms in the primary phase grains of the substrate alloy's surface region to undergo substitution with HRE (heavy rare earth) atoms. This situation complicates the effective control of the entry rate of Dy or Tb from the film into the interior of the primary phase grains, resulting in the tendency for heavy rare earth elements to accumulate within the primary phase grains. Consequently, there is an increased presence of thick-shell grains and reverse-shell grains in both the surface and near-surface regions of the magnet, with the average grain size of the reverse-shell grains being large. Although the magnet produced in Comparative Example 1 shows some improvement in coercivity, the squareness of the demagnetization curve significantly declines. Similarly, the coercivity and squareness of the demagnetization curve for the magnet produced in Comparative Example 2 both show significant decreases.

The above description, in conjunction with the accompanying drawings, details certain embodiments of the present disclosure. However, the disclosure is not limited to the specific details of the embodiments described herein. Within the scope of the technical concepts of the present disclosure, various simple modifications to the technical solutions of the disclosure can be made, and all such modifications are within the protective scope of the disclosure.

Additionally, it should be noted that the various specific technical features described in the specific embodiments can be combined in any suitable manner, provided they do not contradict each other. To avoid unnecessary repetition, this disclosure does not further elaborate on the various possible combinations. Furthermore, any arbitrary combination of the different embodiments of the present disclosure is also considered to be part of the disclosed content of the disclosure, as long as it does not contravene the principles of the disclosure.

1. A cerium (Ce)-containing neodymium-iron-boron (NdFeB) magnet comprising thin-shell grains, reverse-shell grains, and thick-shell grains;
wherein:
a heavy rare earth element (HRE) content in a core of a reverse-shell grain is greater than an HRE content in a shell of the reverse-shell grain, and a thickness of the shell of the reverse-shell grain is greater than 2 micrometers (μm);
an HRE content in a shell of a thick-shell grain is greater than an HRE content in a core of the thick-shell grain, and a thickness of the shell of the thick-shell grain is greater than 2 μm;
an HRE content in a shell of a thin-shell grain is greater than an HRE content in a core of the thin-shell grain, and a thickness of the shell of the thin-shell grain is less than 2 μm;
the HRE is selected from dysprosium (Dy) and/or terbium (Tb);
a ratio of a number N₁ of thin-shell grains in a surface region of the Ce-containing NdFeB magnet to a total number N of grains in the surface region is greater than or equal to 70%, the surface region including a surface of the Ce-containing NdFeB magnet and a region within 50 μm from the surface; and
a ratio of a sum of a number N₂ of reverse-shell grains and a number N₃ of thick-shell grains in a near-surface region of the Ce-containing NdFeB magnet to a total number N′ of grains in the near-surface region is less than or equal to 5%; the near-surface region includes a region from 50 μm to 100 μm from the surface of the Ce-containing NdFeB magnet.

2. The Ce-containing NdFeB magnet according to claim 1, wherein N₁/N≥0.82.

3. The Ce-containing NdFeB magnet according to claim 1, wherein:
in the surface region of the Ce-containing NdFeB magnet, an average grain size of the thin-shell grains is less than or equal to 5 μm; and
the HRE content in the core of the thin-shell grain is less than or equal to 2 weight percent (wt %).

4. The Ce-containing NdFeB magnet according to claim 1, wherein:
in the surface region of the Ce-containing NdFeB magnet, an average grain size of the reverse-shell grains is in a range of 5 to 10 μm; and
the thickness of the shell of the reverse-shell grain is in a range of 2 to 4 μm.

5. The Ce-containing NdFeB magnet according to claim 1, wherein:
in the surface region of the Ce-containing NdFeB magnet, an average grain size of the thick-shell grains is in a range of 5 to 10 μm; and
the thickness of the shell of the thick-shell grain is in a range of 2 to 4 μm.

6. The Ce-containing NdFeB magnet according to claim 1, wherein:
the Ce-containing NdFeB magnet includes RL, Ce, M, B, HRE, and T, where:
RL is selected from one or more elements of Nd, Pr, La, Y, Ho, and Gd, and includes Nd and/or Pr;
M is selected from one or more elements of Al, Cu, Ga, Cr, Ti, and Zr; and
T is Fe and/or Co; and
in the Ce-containing NdFeB magnet, a content of RL is in a range of 19 to 28 wt %, a content of Ce is in a range of 4 to 13 wt %, a content of M is in a range of 0.1 to 2.0 wt %, a content of B is in a range of 0.9 to 1.0 wt %, a content of HRE is in a range of 0.2 to 0.8 wt %, with the remainder being T.

7. A method for preparing the Ce-containing NdFeB magnet according to claim 1, comprising:
performing compacting treatment and sintering treatment on Ce-RL1-T-B-M alloy powder to obtain a base alloy, where:
RL1 is selected from one or more elements of Nd, Pr, La, Y, Ho, Gd, Dy, and Tb, and includes Nd and/or Pr;
M is selected from one or more elements of Al, Cu, Ga, Cr, Ti, and Zr; and
T is Fe and/or Co;
attaching a heavy rare earth (HRE) containing film to the surface of the base alloy, wherein the HRE is selected from Dy and/or Tb; and
subjecting the base alloy with the attached HRE-containing film to diffusion treatment and tempering treatment to obtain the Ce-containing NdFeB magnet;
wherein:
the diffusion treatment includes a first stage diffusion treatment and a second stage diffusion treatment;
a temperature for the first stage diffusion treatment is in a range of 750 to 890° C., with a holding time of 1.5 to 4 hours;
a temperature for the second stage diffusion treatment is in a range of 900 to 950° C., with a holding time of 1.5 to 4.5 hours.

8. The method according to claim 7, further comprising:
cooling the base alloy with the attached HRE-containing film prior to the second stage diffusion treatment.

9. The method according to claim 7, wherein the temperature for the first stage diffusion treatment is in a range of 810 to 850° C.

10. The method f according to claim 7, wherein:
attaching the HRE-containing film to the surface of the base alloy includes applying a diffusion source containing HRE onto the surface of the base alloy using vacuum deposition, magnetron sputtering, slurry coating, immersion, screen printing, roller coating, or spraying to form the film with a thickness in a range of 5 to 30 μm; and
the diffusion source is selected from one or more metals, alloys, or compounds containing HRE.

11. The method according to claim 7, wherein in the Ce-RL1-T-B-M alloy powder, a content of Ce is in a range of 4 to 13 wt %, a content of RL1 is in a range of 19 to 28 wt %, a content of M is in a range of 0.1 to 2.0 wt %, a content of B is in a range of 0.9 to 1.0 wt %, with the balance being T.

12. The method according to claim 7, further comprising:
preparing Ce-RL1-T-B-M alloy strips using a rapid solidification process; and
conducting hydrogen crushing treatment and micro-pulverization treatment on the Ce-RL1-T-B-M alloy strips to obtain the Ce-RL1-T-B-M alloy powder, a D50 particle size of the Ce-RL1-T-B-M alloy powder being in a range of 3 to 5.5 μm.

13. The method according to claim 7, wherein:
the compacting treatment is an orientation compacting treatment, conducted under a magnetic induction intensity of 1.5 to 2.0 T;
the sintering treatment is carried out at a temperature of 1010 to 1050° C. with a holding time of 2 to 6 hours;
the tempering treatment is conducted at a temperature of 480 to 640° C. with a holding time of 1 to 4 hours.
